(19) United States
(12) Patent Application Publication
(10) Pub. No.: US 2011/0225269 A1
(43) Pub. Date: Sep. 15, 2011

(54) System For Efficient Allocating And Monitoring Of Public Transport

(76) Inventors: Wee, Shong Clement Yap, Singapore (SG); Sing Khiang Low, Singapore (SG)

(21) Appl. No.: 13/129,265

(22) PCT Filed: Feb. 15, 2008
(86) PCT No.: PCT/SG2008/000434

§ 371 Date: May 13, 2011

(51) Int. Cl. G06F 15/16

(52) U.S. Cl. 709/219

(57) ABSTRACT

A method, a machine-readable medium and a system for efficient allocating of public transport. The allocation method comprises receiving request data from an input module and determining vehicle data of each of a plurality of vehicles. The request data comprises request location and the vehicle data comprises vehicle location. The allocation method further comprises selecting a portion of the plurality of vehicles and sending a request query to at least one of the selected portion of the plurality of vehicles. The vehicle data of each of the selected portion of the plurality of vehicles complies with at least one selection criteria and the request query comprises the request location. At least one of the selected portions of the plurality of vehicles is allocatable to the request module based on and in response to the sent request query.

### FIELD OF INVENTION

The present invention generally relates to public transportation. More particularly, the invention relates to allocation and monitoring of public transportation.

### BACKGROUND

Transportation is an essential aspect of everyday life. Particularly, most people require transportation to travel from one location to another, especially when distance of the travel is considerable. There are several modes of transportation. The modes of transportation are generally classified into private transportation mode and public transportation mode. The private transportation mode generally refers to private transportation where a vehicle is owned by a user for the user's private use. The public transportation mode generally refers to a public transportation service owned by a service provider to provide transportation services to general public. The transportation service includes various modes of public transport such as taxis or buses.

General concerns for transportation are, for example, time of travel from one location to another and fuel consumption efficiency during the travel. Such concerns are especially relevant to service providers of public transport as the service providers have to operate many vehicles at regular intervals to meet the requirement of the general public. The general public refers to passengers using the public transport providers. In one example, a service provider such as a public bus service operator conventionally operates by allocating and dispatching buses for a designated route. The buses depart from a bus terminal station at regular time intervals. Such conventional operation does not take into account or monitor adverse traffic conditions on the public road or quantity of passengers taking the bus. Consequently, an overlap of dispatched buses may occur on the designated travel route or passengers may not be able to board the bus due to overcrowding. Hence the time of travel of the passengers may be adversely lengthened. Additionally the fuel consumption efficiency will be considerably lower in the event of the overlap.

In another example, service providers such as taxi service operators conventionally operate by dispatching taxis in general to the public roads. Generally, the dispatched taxis travel randomly on the public road to pick up passengers. Typically when a passenger desires to reserve a taxi, the passenger conventionally has to call a specific taxi service operator to make a request for a reservation. Upon receiving the request, the taxi service operator broadcasts the request to the taxis dispatched by that specific taxi service operator and a taxi available to pick the passenger up respond to the broadcast. The taxi service operator allocates the taxi available to the request and communicates to the passenger that the reservation is confirmed. It can readily be appreciated that the available taxi may be a considerable distance away from the passenger. Hence the time of travel of the passenger and the fuel consumption efficiency of the available taxi are consequently adversely affected.

It is therefore desirable to provide a solution to address at least one of the foregoing problems of the conventional operations.

### SUMMARY

In accordance with one aspect of the invention, an allocation method is provided. The allocation method comprises receiving request data from an input module and determining vehicle data of each of a plurality of vehicles. The request data comprises request location and the vehicle data comprises vehicle location. The allocation method further comprises selecting a portion of the plurality of vehicles and sending a request query to at least one of the selected portion of the plurality of vehicles. The vehicle data of each of the selected portion of the plurality of vehicles complies with at least one selection criteria and the request query comprises the request location. At least one of the selected portions of the plurality of vehicles is allocatable to the request module based on and in response to the sent request query.

In accordance with another aspect of the invention, a system is provided. The system comprises an input module for generating a request and a source module providing source data of each of a plurality of available vehicles. The request comprises request location. The system further comprises a source module providing source data of each of a plurality of available vehicles and a control module. The source data comprises current location of each of the plurality of available vehicles. The control module is communicable with the input module and the source module so that a group of available vehicles is identifiable from the plurality of available vehicles. The source data of each of the available vehicles from the group of available vehicles complies with at least one criteria data, wherein the control module sends a request query to at least one of the available vehicles from the group of available vehicles, the request query comprises the request location, and at least one of the available vehicles from the group of available vehicles is allocatable to the input module based on and in response to the sent request query.

In accordance with yet another aspect of the invention, a machine-readable medium is provided. The machine-readable medium having stored therein a plurality of programming instructions, which when executed, the instructions cause the machine to receive a request from an input module and determine source data of each of a plurality of available vehicles. The request comprises request location and the source data comprises current location of each of the plurality of available vehicles. The machine is further caused to identify a group of available vehicles from the plurality of available vehicles and send a request query to at least one of the available vehicles from the group of available vehicles. The source data of each of the available vehicles from the group of available vehicles complies with at least one criteria data and the request query comprises the request location, wherein at least one of the available vehicles from the group of available vehicles is allocatable to the input module based on and in response to the sent request query.

### BRIEF DESCRIPTION OF THE DRAWINGS

The invention is described hereinafter with reference to the following drawings, in which:

FIG. 1a-h show a system for allocating and monitoring public transport in accordance with one aspect of the invention; and

FIG. 2 shows a method employed by the system in accordance with another aspect of the invention.

### DETAILED DESCRIPTION

For purposes of brevity and clarity, the description of the present invention is limited hereinafter to a method and a system for allocating and monitoring public transport. This however does not preclude various embodiments of the invention from other applications where fundamental principles prevalent among the various embodiments of the invention such as operational, functional or performance characteristics are required.

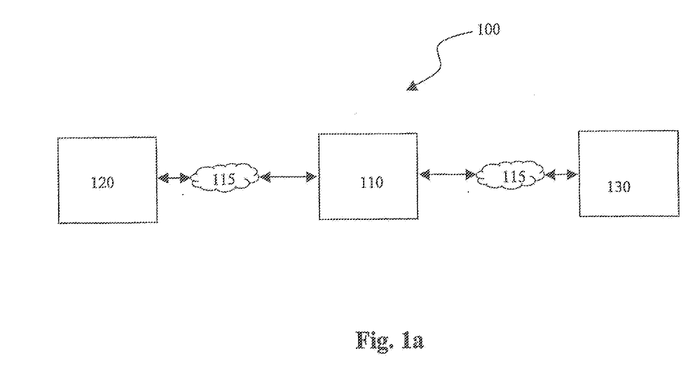

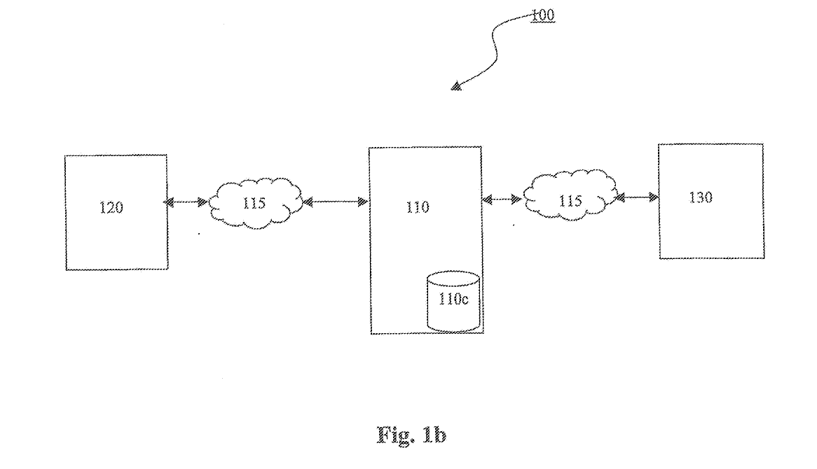

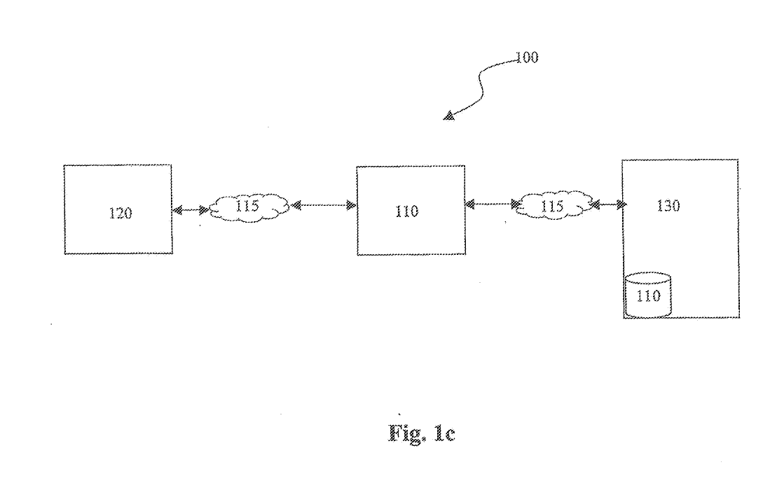

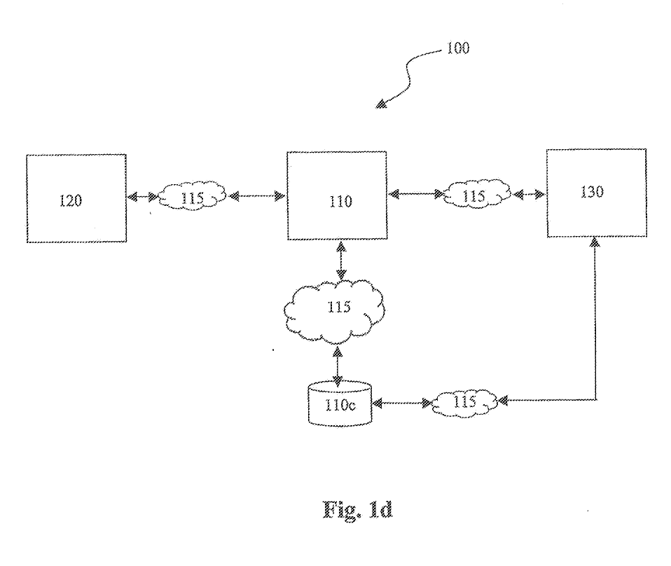

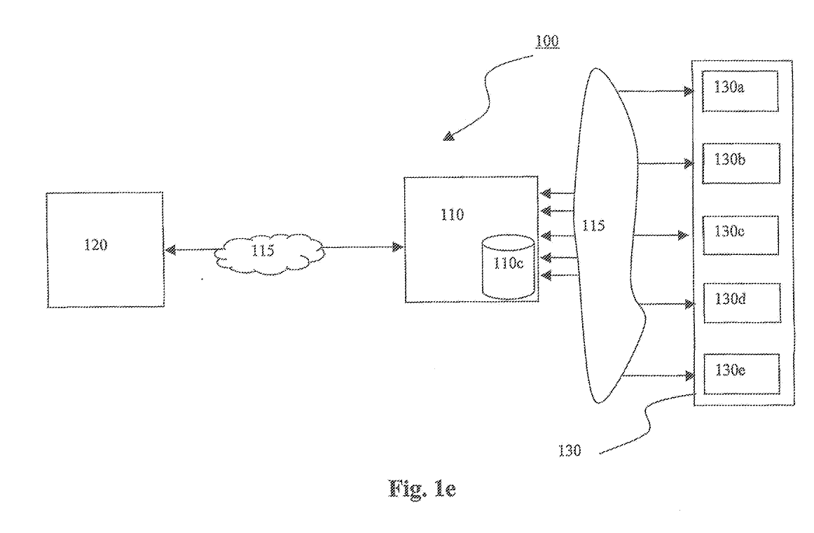

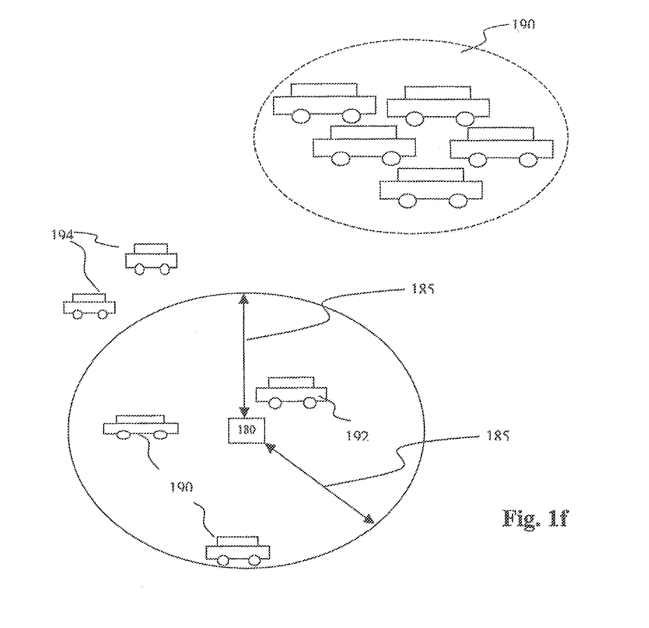

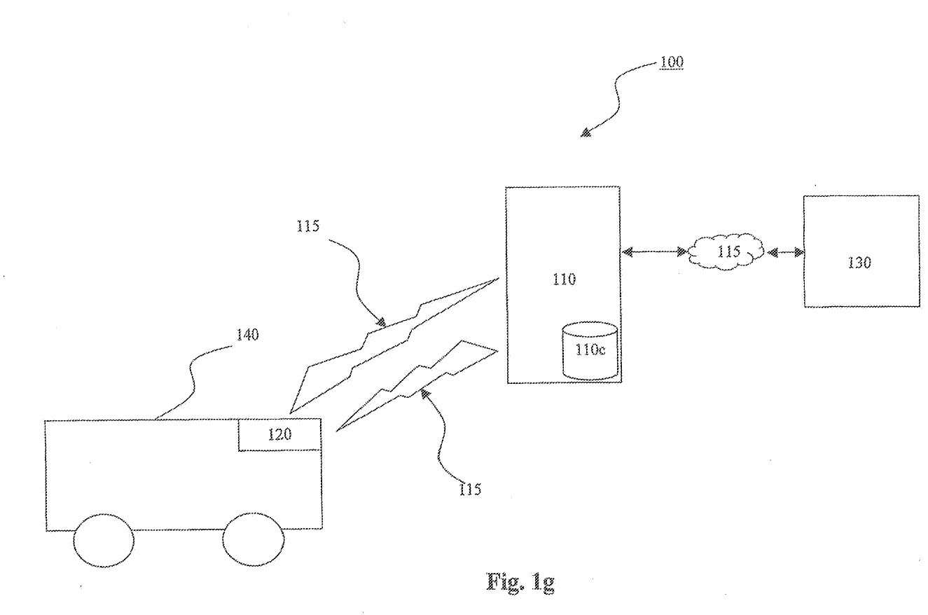

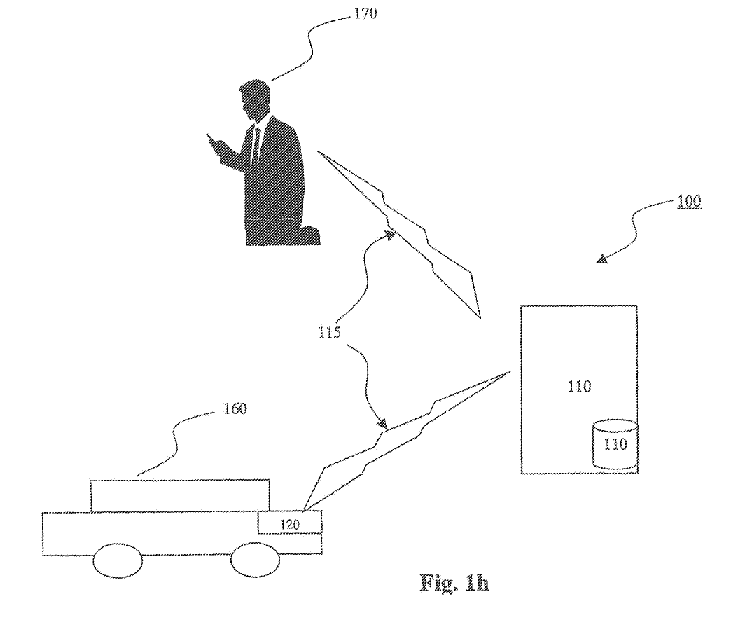

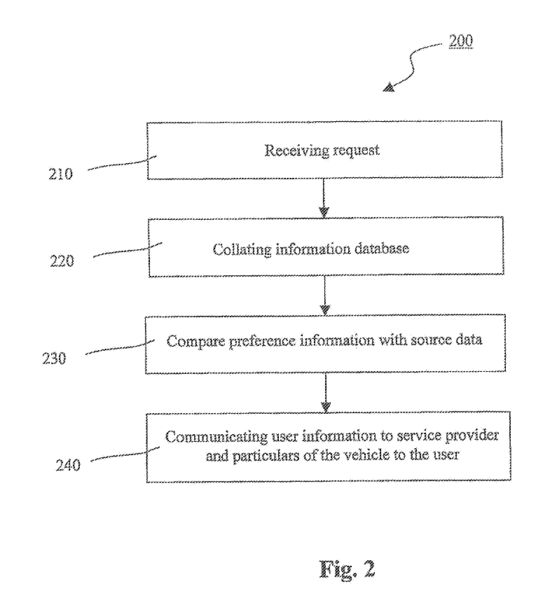

An exemplary embodiment of the invention, a system 100 for allocating and monitoring public transport for addressing the foregoing problems of conventional public transport allocating and monitoring implementations, is described hereinafter with reference to FIG. 1a-h. The system 100, as shown in FIG. 1a, comprises a control module 110. The control module 110 comprises a data exchange module and a data processing module. The data exchange module of the control module 110 is coupled with an input module 120 and a source module 130. The input module 120 and the source module 130 communicate with the control module 110. The control module 110 interfaces between the input module 120 and the source module 130.

A user preferably uses the input module 120 for providing input data to the data exchange module of the control module 110. The input module 120 is preferably a communication device such as a mobile phone and the input is preferably a request. Alternatively, the input module is a landline telephone or a personal digital assistant (PDA) having telecommunication capabilities. The request is preferably made by the user using the mobile phone and communicated to the communication module 110 via a communications network 115. Alternatively, the user communicates the request to the control module 110 using the PDA via electronic mail (e-mail) over the communications network 115. Examples of the communications network are a telephone network, a global positioning system (GPS) network, an assisted-GPS (A-GPS) system network, locator-based mobile triangulation, WiFi-based positioning and an internet network. The data exchange module of the control module 110, preferably, communicates with the source module 130 to collate source data within an information database 110c as shown in FIG. 1b. Preferably, the information database 110c is integrated within the control module 110. Alternatively, the information database 110c is incorporated within the source module 130 or within the system 100, outside of the control module 110, as shown in FIG. 1c and FIG. 1d respectively. The source data is communicable from the source module 130 to the information database 110c via, for example, the communications network 115.

In an exemplary application, the system 100 is implemented in a public transportation reservation network. As earlier mentioned, the system 100 is implemented in a reservation network for public transportation. However, it is readily appreciated that the system 100 is also implementable for private transportation. The control module 110 is preferably a computer (not shown) and the source module 130 comprises a plurality of service providers 130a-130e as shown in FIG. 1e. The public transportation reservation network is preferably applied for public transportation vehicles such as taxis and each of the plurality of service providers 130a-130e are taxi service providers. The information database 110c is, for example, a hard disk drive (HDD) of the computer. The information database 110c is an example of a machine readable medium and the control module 110 is an example of a machine reading the information database 110c. The information database 110c contains a plurality of programming instructions. The source data comprises source details such as name of the taxi service provider, current location of available taxis belonging to each of the plurality of the taxi service providers and particulars of available taxis. The particulars of each of the available taxis preferably comprise at least one of contact number of the taxi service provider, estimated time of arrival (ETA), vehicle characteristics, vehicle charges and car registration numbers of each of the available taxis. The car registration number of each of the available taxi is, preferably, a vehicle identifier. The vehicle characteristics comprise characteristics of the vehicle such as make of the vehicle and type of the vehicle. The type of vehicle is, for example, a minivan, a sedan or a four-wheel drive. The source data on the information database 110c is preferably updated in real-time. For example, when the location of an available taxi belonging to a specific taxi service provider has changed due to travel of the taxi, the change in location of the taxi is monitored and reflected in the information database 110c as the taxi is traveling. Preferably, the real-time updated source data is communicated to the control module 110 from the source module 130 via the communications network 115.

The user uses the input module 120 to communicate with the control module 110 to register the request for a taxi reservation. The request preferably comprises one or both of user information and criteria data. The user information comprises the user's personal particulars such as the user's name, the user's contact number and current location of the user. The current location of the user is also referred to as a request location and the user information is an identifier identifying the user. The input module is preferably identified by the user's contact number. The criteria data comprises preference information for the taxi reservation. The preference information is preferably proximity preference. The proximity preference, otherwise referred to as preferred distance, is preferably the proximity in location of an available taxi with respect to the user. Preferably, the available taxi belongs to any of the plurality of taxi service provider. In one example, as shown in FIG. 1f, the data processing module of the control module 110, upon receiving the preference information of proximity preference from the input module 120, compares current location 180 of the user with the source data to identify a group of available taxis 190 within a radius 185 about the current location 180 of the user, regardless of the taxi service provider the taxis within the group of available taxis 190 are associated with. The radius 185, in this example, is the proximity preference. Taxis not within the radius 185 are considered by the control module 110 as unavailable taxis 194 and are hence not identified by the control module 110 as part of the group of available taxis 190. Preferably, the control module 110 communicates the request via a request query to the group of available taxis 190. Alternatively, the control module 110 communicates the request via a request query to the unavailable taxis 194. In a further example, the control module 110, upon receiving the preference information of proximity preference from the input module 120, compares the current location 180 of the user with the source data to identify the nearest available taxi 192 to the current location 180 of the user, regardless of the taxi service provider the nearest available taxi 192 is associated with.

Alternatively, the preference information is taxi service provider preference. In other words, the user specifies the particular taxi service provider that is preferred and the control module 110, upon receiving such a request, compares the preference information with the source data to identify available taxis belonging to the preferred taxi service provider. Preferably the available taxis of the preferred service provider are within the radius 185. Other preference information, such as traveling route or vehicle type, is also implementable. Alternatively, in the absence of the criteria data, the control module 110 compares the current location 180 of the user with the source data to identify the nearest available taxi 192 to the current location 180 of the user. Hence the control module 110 assumes that the preference information is a default data of “proximity preference”, in the absence of the criteria data. Preferably, the default data is stored within the information database 110c of the control module 110.

Upon a positive identification of the preference information with respect to the source data, an association between the request and the source data is established. In other words, a match between the user and the taxi or the taxi service provider is established. The preference information is positively identified with respect to the source data when, for example, the group of available taxis 190 is identified to be within the radius 185 about the current location 180 of the user. Preferably a first available taxi in the group of available taxis 190 to positively acknowledge the request query is given priority in the match. Alternatively, where the user desires to reserve more than one taxi, the available taxis in the group of available taxis 190 to first positively acknowledge the request query are given priority in the match. A positive acknowledgement to the request query is a response data transmitted by at least one of the available taxis from the group of available taxis 190 to one or both the control module 110 and the input module 120, signifying an acceptance by the available taxi to pick up the user. Preferably the response data comprises particulars of the available taxi and after the match is established, the control module 110 proceeds to communicate the user information to the first available taxi or the taxi service provider of the first available taxi and the response data of the first available taxi to the user. Alternatively, after the match is established, the control module 110 sends a confirmation to at least one of the user, via the input module 120, and the first available taxi or taxi service provider of the first available taxi. Following this, upon positive acknowledgement of the confirmation, the control module 110 proceeds to communicate the user information to the first available taxi or the taxi service provider of the first available taxi and the response data of the first available taxi to the user. The taxi particulars are otherwise referred to as particulars of the vehicle. The confirmation sent by the control module 110 is preferably a confirmation to accept or reject the match. A positive acknowledgement of the confirmation signifies a confirmation to accept the match.

In an event where either the first available taxi or the user rejects the confirmation, another match is preferably established between a next available taxi and the user. The next available taxi is, for example, a second taxi in the group of available taxis 190 to positively acknowledge the request query. Alternatively, a rejection of the confirmation by the user terminates further establishment of matches. The confirmation is rejectable either before acceptance of the match with the first available taxi or after the acceptance of the match with the first available taxi. For example, in a situation where the first available taxi is not able to reach the user within the ETA due to adverse traffic conditions such as traffic congestion, the first available taxi proceeds to transmit a delay alert to the user. The user, upon receiving the delay alert, may decide to either continue waiting for the arrival of the first available taxi or reject the match with the first available taxi. After the rejection of the match with the first available taxi, another match with the next available taxi within the group of available taxis 190 is then established with the user.

Therefore, from the above, the plurality of programming instructions of the storage area 110c, when executed, causes the control module 110 to receive the request from the input module 120 and obtain the source data from the source module 130. The control module 110 processes the request by comparing the request with respect to the source data to establish the match.

In another exemplary application, the system 100 is implemented in a public transportation monitoring network. Examples of the public transportation in the public transportation network are vehicles such as buses or taxis. The monitoring network is preferably used for an application such as efficient resource allocation. An example of efficient resource allocation is efficient deployment of the vehicles. Preferably, the system 100 employs a first monitoring scheme, a second monitoring scheme and a third monitoring scheme. The first monitoring scheme is implementable by monitoring location of a vehicle as the vehicle is traveling in a designated traveling route. The input module 120 is preferably provided on the vehicle and the control module 110 is a control station of a terminal station of the vehicle. The terminal station represents the source module 130. The input module 120 transmits particulars of the vehicle to the control module 110. Preferably, the particulars of the vehicle comprise at least one of number of the vehicle, the designated traveling route of the vehicle and the location of the vehicle. The control module 110 updates and collates particulars of the vehicle and, based on the location of the vehicle, determines the appropriate departure time of the next vehicle traveling on the same designated traveling route, from the source module 130. Preferably, the particulars of the vehicle are monitored and updated in the information database 110c by the control module 110. Alternatively the location of the vehicle is monitored and updated in the information database 110c as the vehicle 140 arrives at designated stops along the designated traveling route. For example, as shown in FIG. 1g, the location of a bus 140 traveling along the designated traveling route is monitored via transmission of the particulars of the bus 140 from the input module 120 to the control module 110 via the communications network 115 as the bus 140 arrives at designated bus stops along the designated traveling route.

The second monitoring scheme is implementable by monitoring number of passengers with respect to capacity of the vehicle. The capacity of the vehicle is the maximum number of passengers the vehicle is able or licensed to ferry. For example, the number of passengers on the bus is monitored and transmitted by the input module 120 to the control module 110. When the number of passengers on board the bus is close to the capacity of the bus, the control module 110 dispatches the next bus from the source module 130 to ferry passengers traveling along the same bus route.

The third monitoring scheme is implementable by monitoring the number of passengers with respect to number of available public transportation vehicles such as taxis. In other words, the third monitoring scheme is implementable as a taxi demand versus supply matching scheme. For example, the number of taxis joining a pick up queue at a taxi stand to pick up passengers is obtainable by the system 100 by tallying transmission, via the input module 120, from each of the taxis queuing at the taxi stand. The taxi stand is, for example, equipped with a sensor (not shown) for determining or estimating the number of passengers queuing for taxis at the taxi stand. In an event where the taxi demand is not matched with the supply, for example the number of taxis is less than the number of passengers waiting at the taxi stand, the control module 110 of the system 100 transmits a request to available taxis around the vicinity of the taxi stand to increase the number of taxis joining the pick up queue at the taxi stand. Alternatively, an available taxi communicates, via the input module 120, with the system 100 to ascertain if the taxi demand and the supply are matched. In an event where the taxi demand and the supply are matched, the available taxi may consider not joining the pick up queue at the taxi stand.

The monitoring network is alternatively used for other applications such as security tracking or vehicle sharing. An example of security tacking is an incorporation of a distress function on the vehicle and upon a distress situation such as the vehicle breakdown, the distress function is activated. When the distress function is activated, a distress signal is transmitted along with the vehicle particulars, via the input module 120, to the control module 110 to signify a positive distress status of the vehicle. Upon receiving the distress signal, the control module 110 preferably proceeds to effect appropriate corrective action such as dispatching a replacement vehicle or a repair vehicle from the source module 130. Alternatively, when the control module 110 perceives that the vehicle has remained stationary at the same location for a long period of time, the control module 110 communicates with the vehicle, via the input module 120, to ascertain if the distress status of the vehicle is positive before proceeding to effect the appropriate corrective action. The control module 110 perceives that the vehicle has remained stationary at the same location for a long period of time when, for example, the location of the vehicle has not been updated in the information database for a long period of time. In an event where the control module 110 is not able to ascertain if the distress status is positive due to, for example, failed communication between the control module 110 and the input module 120 of the vehicle, appropriate corrective action is preferably effected.

An example of vehicle sharing is car-pooling where a plurality of users share the same vehicle, such as an automobile, for transportation. The control module 110 of the system 100 collates user information from the plurality of users in the information database 110c, via the input module 120. The control module 110 allocates the users sharing the same automobile. Preferably, the control module 110 allocates the users based on the preference information.

In yet another exemplary application, the system 100 is implemented in a vehicular maintenance network. The vehicular maintenance network is implementable by monitoring data of the vehicle. The data of the vehicle comprises hardware information of the vehicle. The hardware information of the vehicle comprises information from various hardware systems in the vehicle. The various hardware systems are automotive applications in the vehicle. Examples of hardware systems in the vehicle are battery on or off detection system, ignition detection system, key insertion detection system, odometer, brake system, headlights system and, heating ventilation and air conditioning (HVAC) system.

The vehicular maintenance network is preferably applied in applications such as vehicular health determination. Preferably, information from each of the hardware systems of the vehicle is used in the vehicular health determination. The information from each of the hardware systems preferably comprises a measured data quantifying health of each of the hardware systems. For example, brake lining information is obtainable from the brake system and the brake lining information is the measured data used to determine the health of the brake system. The information from the hardware system is preferably obtainable from a Control Area Network (CAN) of the vehicle.

Preferably the control module 110 retrieves the data of the vehicle from the CAN of the vehicle. The CAN of the vehicle corresponds to the input module 120. The control module 110 collates and stores the data of the vehicle in the information database 110c. The control module 110, preferably, receives a specification data of the vehicle from the source module 130. The source module 130 is preferably a manufacturer of the vehicle. The specification data preferably comprises at least one of optimal parameter and minimum parameter of each of the hardware system of the vehicle. The optimal parameter defines a quantified measurement of the hardware system to signify that the hardware system is in a good health condition and the minimum parameter defines the quantified measurement of the hardware system to signify that the hardware system is in a poor health condition. Preferably the control module 110 compares the measured data of each of the hardware system from the input module 120 with the specification data from the source module 130 and determines the health of the vehicle. Upon the determination of the health of the vehicle, appropriate maintenance procedures are preferably effected by the control module 110. The maintenance procedures include alerting a maintenance team when a poor health condition of a hardware system is determined and servicing or repairing the hardware system in the poor health condition. For example, upon determining that the brake system is operating at the minimum parameter, the control module 110 determines that the brake system of the vehicle is in the poor health condition and alerts the maintenance team to service the brake system.

Alternatively, the vehicular maintenance network is applied in other applications such as power status check. The power status check is preferably a check to detect a power abnormality in the vehicle. As shown in FIG. 1h, the vehicle is preferably an automobile 160 operated by a driver 170. An example of a power abnormality is a scenario where the driver 170 of the automobile 160 does not turn off the headlight of the automobile 160 when the automobile 160 engine is turned off In this scenario, the control module 110, when retrieving the data of the automobile 160 from the input module 120 via the communications network 115, preferably receives information from the headlights system that the headlights are turned on and information from the key insertion system that no key is inserted. Following the detection of a power abnormality, the control module 110 preferably proceeds to alert the driver 170 of the automobile 160. The control module 110 alerts the driver 170 of the automobile 160 by, for example, communicating a short message service (SMS) via the communications network 115 to the mobile phone of the driver 170.

It is readily appreciated that the system 100 is also implementable for various other transportation applications such as private transportation and a parcel/delivery dispatch transportation service.

In an exemplary situation, the delivery dispatch transportation service is tasked to deliver a parcel, via land travel, from its headquarters (HQ) to a destination. Preferably, the delivery dispatch transportation owns a plurality of delivery vehicles. The HQ designates a plurality of rest stops between the HQ and the destination. For example, the destination is five hundred miles away from the HQ and a rest stop is designated by the HQ at every one hundred miles. The preferred distance in this example is therefore provided by the HQ at one hundred miles. The HQ dispatches a first available delivery vehicle to deliver the parcel and further designates the ETA for the first available delivery vehicle to arrive at each of the plurality of rest stops. In an event where the first available delivery vehicle is not able to arrive at one of the rest stops within the ETA due to vehicle breakdown or adverse traffic conditions such as traffic congestion, the first available delivery vehicle of the delivery dispatch transportation service preferably proceeds to transmit a delay alert to the system 100.

The system 100, upon receiving the delay alert, sends a request query to identify a group of available delivery vehicles from the plurality of delivery vehicles. One of the available delivery vehicles from the group of available delivery vehicles is hence a replacement delivery vehicle for the first available delivery vehicle. In an example, where the first delivery vehicle suffers a vehicle breakdown, the system 100 identifies the group of available delivery vehicle within the preferred distance. In another example, where the first delivery vehicle is not able to arrive at one of the rest stops within the ETA due to adverse traffic conditions, the system 100 identifies the group of available delivery vehicle not within the preferred distance and the replacement delivery vehicle proceeds to deliver the parcel to the designation via another route.

Preferably the system 100 employs a method for allocating and monitoring public transport. The method 200 comprises receiving the request of the user at step 210 and collating the information database at step 220. Following this, at step 230, the request is compared with the information database to establish an association. The method 200 further comprises communicating the user information to the service provider and communicating particulars of the vehicle to the user at step 240

In the foregoing manner, a system and method for allocating and monitoring public transport is described for addressing at least one of the foregoing disadvantages. The invention is not to be limited to specific forms or arrangements of parts so described and it will be apparent to one skilled in the art in view of this disclosure that numerous changes and/or modification can be made without departing from the scope and spirit of the invention.

1. An allocation method comprising:
receiving a request from an input module, the request comprising request location;
determining source data of each of a plurality of available vehicles, the source data comprising current location of each of the plurality of available vehicles;
identifying a group of available vehicles from the plurality of available vehicles, the source data of each of the available vehicles from the group of available vehicles complying with at least one criteria data; and
sending a request query to at least one of the available vehicles from the group of available vehicles, the request query comprising the request location,
wherein at least one of the available vehicles from the group of available vehicles is allocatable to the input module based on and in response to the sent request query.

2. The method as in claim 1, further comprising:
allocating at least one of the available vehicles from the group of available vehicles to the input module based on and in response to the sent request query.

3. The method as in claim 2, allocating at one of the available vehicles from the group of available vehicles to the request module comprising:
receiving response data from each of the available vehicles from the group of available vehicles; and
sending the response data received from each of the available vehicles from the group of available vehicles to the input module to thereby allocate one of the available vehicles from the group of available vehicles to the input module, the source data further comprising a vehicle identifier.

4. The method as in claim 3, the response data received from each of the each of the available vehicles from the group of available vehicles comprising at least one of the vehicle identifier, estimated time of arrival (ETA), vehicle characteristics and vehicle charges.

5. The method as in claim 1, the request comprising at least one of an identifier and the at least one criteria data.

6. The method as in claim 5, identifying the group of available vehicles from the plurality of available vehicles comprising:
determining actual distance of the current location of each of the plurality of available vehicles from the request location; and
comparing the actual distance of each of the plurality of available vehicles with a preferred distance to thereby obtain the group of available vehicles from the plurality of available vehicles, the at least one criteria data comprising shortest at least one distance, the actual distance of each available vehicle from the group of available vehicles being one of the shortest at least one distance.

7. The method as in claim 5, the identifier one of identifying the input module and being a user name associated with a user of the input module.

8. The method as in claim 5, the at least one criteria data being at least one of preferred distance, preferred service provider and preferred vehicle type.

9. The method as in claim 8, identifying the group of available vehicles from the plurality of available vehicles comprising:
matching at least one of corresponding service provider and corresponding vehicle type with the at least one criteria data, the vehicle data of each of the plurality of vehicles comprising the at least one of corresponding service provider and corresponding vehicle type.

10. The method as in claim 8, identifying the group of available vehicles from the plurality of available vehicles comprising:
determining actual distance of the current location of each of the plurality of vehicle from the request location; and
comparing the actual distance of each of the plurality of vehicles with the preferred distance to thereby obtain the group of available vehicles from the plurality of available vehicles, the actual distance of each available vehicle from the group of available vehicles from the plurality of available vehicles not exceeding the preferred distance.

11. The method as in claim 8, identifying the group of available vehicles from the plurality of available vehicles comprising:
determining actual distance of the current location of each of the plurality of vehicle from the request location; and
comparing the actual distance of each of the plurality of vehicles with the preferred distance to thereby obtain the group of available vehicles from the plurality of available vehicles, the actual distance of each available vehicle from the group of available vehicles from the plurality of available vehicles exceeding the preferred distance.

12. The method as in claim 11, further comprising:
receiving delay alert from each of the available vehicles from the group of available vehicles; and
sending the delay alert received from each of the available vehicles from the group of available vehicles to the input module to thereby allocate at least one of the available vehicles from the group of available vehicles to the input module, the source data further comprising the vehicle identifier.

13. The method as in claim 1, the input module being a communication device.

14. The method as in claim 1, receiving request data from the input module comprising:
generating the request location via at least one of a global positioning system (GPS), a WiFi-based system and a locator-based mobile triangulation of the input module.

15. The method as in claim 1, receiving request data from the input module comprising:
operating the input module by a user for generating the request location.

16. The method as in claim 1, determining source data of each of the plurality of vehicles comprising:
receiving vehicle location generated by a global positioning system of each of the plurality of vehicles.

17. A system comprising:
a control module being communicable with an input module and a source module, the control module comprising:
a data exchange module, the data exchange module receiving a request from the input module and source data of each of a plurality of available vehicles from the source module, the request comprises a request location and the source data comprises current location of each of the plurality of available vehicles; and
a data processing module, the request and the source data receivable, from the data exchange module, and processable by the data processing module to thereby identify a group of available vehicles from the plurality of available vehicles and the source data of each of the available vehicles from the group of available vehicles complies with at least one criteria data,
wherein a request query is providable by the control module to at least one of the available vehicles from the group of available vehicles, the request query comprises the request location, and at least one of the available vehicles from the group of available vehicles is allocatable to the input module based on and in response to the sent request query.

18. The system as in claim 17, the at least one of the available vehicles from the group of available vehicles being allocated to the input module based on and in response to the sent request query.

19. The system as in claim 18, response data is received from each of the available vehicles are received and the received response data is sent to the input module to thereby allocate one of the available vehicles from the group of available vehicles to the input module, the source data further comprising the vehicle identifier.

20. The system as in claim 19, the response data received from each of the each of the available vehicles from the group of available vehicles comprises at least one of a vehicle identifier, estimated time of arrival (ETA), vehicle characteristics and vehicle charges.

21. The system as in claim 17, the request comprising at least one of an identifier and the at least one criteria data.

22. The system as in claim 21 wherein actual distance of the current location of each of the plurality of available vehicles from the request location is determined and the actual distance of each of the plurality of available vehicles is compared with a preferred distance to thereby obtain the group of available vehicles from the plurality of available vehicles, the at least one criteria data comprising shortest at least one distance, the actual distance of each available vehicle from the group of available vehicles being one of the shortest at least one distance.

23. The system as in claim 21, the identifier one of identifying the input module and being a user name associated with a user of the input module.

24. The system as in claim 21, the at least one criteria data being at least one of preferred distance, preferred service provider and preferred vehicle type.

25. The system as in claim 24, at least one of corresponding service provider and corresponding vehicle type is matched with the at least one criteria data, the source data of each of a plurality of vehicles comprising the at least one of corresponding service provider and corresponding vehicle type.

26. The system as in claim 24, wherein actual distance of the current location of each of the plurality of vehicle from the request location is determined and the actual distance of each of the plurality of vehicles is compared with the preferred distance to thereby obtain the group of available vehicles from the plurality of available vehicles, the actual distance of each available vehicle of the group of available vehicles not exceeding the preferred distance.

27. The system as in claim 24, wherein actual distance of the current location of each of the plurality of vehicle from the request location is determined and the actual distance of each of the plurality of vehicles is compared with the preferred distance to thereby obtain the group of available vehicles from the plurality of available vehicles, the actual distance of each available vehicle of the group of available vehicles exceeding the preferred distance.

28. The system as in claim 27 wherein a delay alert is receivable from each of the available vehicles from the group of available vehicles and the delay alert is sent to the input module after the delay alert is received from each of the available vehicles from the group of available vehicles to thereby allocate at least one of the available vehicles from the group of available vehicles to the input module, the source data further comprising the vehicle identifier.

29. The system as in claim 17, the input module being a communication device.

30. The system as in claim 17, the request data from the input module receivable via at least one of a global positioning system (GPS), a WiFi-based system and a locator-based mobile triangulation of the input module.

31. The system as in claim 417, the input module operable by a user for generating the request location.

32. A machine-readable medium having stored therein a plurality of programming instructions, which when executed, the instructions cause the machine to:
receive a request from an input module, the request comprising request location;
determine source data of each of a plurality of available vehicles, the source data comprising current location of each of the plurality of available vehicles;
identify a group of available vehicles from the plurality of available vehicles, the source data of each of the available vehicles from the group of available vehicles complying with at least one criteria data; and
send a request query to at least one of the available vehicles from the group of available vehicles, the request query comprising the request location,
wherein at least one of the available vehicles from the group of available vehicles is allocatable to the input module based on and in response to the sent request query.

33. The machine-readable medium as in claim 32, wherein the plurality of programming instructions, which when executed, the instructions cause the machine to:
allocate at least one of the available vehicles from the group of available vehicles to the input module based on and in response to the sent request query.

34. The machine-readable medium as in claim 33, wherein the plurality of programming instructions, which when executed, the instructions cause the machine to:
receive response data from each of the available vehicles from the group of available vehicles; and
send the response data received from each of the available vehicles from the group of available vehicles to the input module to thereby allocate one of the available vehicles from the group of available vehicles to the input module, the source data further comprising the vehicle identifier.

35. The machine-readable medium as in claim 32, wherein the plurality of programming instructions, which when executed, the instructions cause the machine to:
determine actual distance of the current vehicle location of each of the plurality of available vehicles from the request location; and
compare the actual distance of each of the plurality of available vehicles with a preferred distance to thereby obtain the group of available vehicles from the plurality of available vehicles, the at least one criteria data comprising shortest at least one distance, the actual distance of each available vehicle from the group of available vehicles being one of the shortest at least one distance.

36. The machine-readable medium as in claim 32, wherein the plurality of programming instructions, which when executed, the instructions cause the machine to:
match at least one of corresponding service provider and corresponding vehicle type with the at least one criteria data, the vehicle data of each of a plurality of vehicles comprising the at least one of corresponding service provider and corresponding vehicle type.
